(19) United States
(12) Patent Application Publication
(10) Pub. No.: US 2015/0269873 A1
(43) Pub. Date: Sep. 24, 2015

(54) Clinical Signage System with Reversible Information Cards and Associated Method for Use

(71) Applicant: Michael Graves & Associates, Princeton, NJ (US)

(72) Inventors: Thomas Rowe, Princeton, NJ (US); James Wisniewski, Buckingham, PA (US)

(21) Appl. No.: 14/664,156

(22) Filed: Mar. 20, 2015

Related U.S. Application Data
(60) Provisional application No. 61/968,746, filed on Mar. 21, 2014.

(51) Int. Cl. G09F 7/02; G09F 1/12

(52) U.S. Cl. CPC G09F 7/02; G09F 1/12; G09F 2007/1843

(57) ABSTRACT

Clinical signage systems with reversible, reusable information cards with warnings, precautions, status, or other information printed on one side assembled into a card holder and methods for using same. The reversible signs can be selectively turned to make the warnings, precautions, or other information visible or hidden to tailor the signage to a particular patient or patient room condition or area of a medical facility. The clinical signage system provides a reliable and easy to use system for clear communication of patient or room or area conditions to healthcare professionals or visitors. The signage system is easy to clean and, with selective material choice, may be antibacterial to help prevent the spread of infectious diseases or contagions.

### CROSS REFERENCE TO RELATED APPLICATION

This application is related to and claims priority benefits from U.S. Provisional Application Ser. No. 61/968,746 (“the '746 application”), filed on Mar. 21, 2014, entitled “Clinical Signage.” The '746 application is hereby incorporated in its entirety by this reference.

### FIELD OF THE INVENTION

This application relates to signage systems and, more particularly, clinical signage systems with reversible information cards.

### BACKGROUND

Hospitals and healthcare facilities are required to post information outside of patient rooms to advise healthcare professionals and visitors of potential dangers or protocols that must be observed inside the patient room. Today, hospitals sometimes use small, single use, cardboard signs to post notifications about patient protocols or hazards. However, these signs are undersized, difficult to read, and are often not current because hospital staff must change out signs each time room occupancy or conditions change. Current hospital signs are also an infection risk because they are difficult to clean and often located near touch points. Bacteria and viruses can survive on these signs and transmit infection to patients, visitors, or hospital staff. Because of these challenges, hospitals sometimes ignore the signage requirements altogether in violation of applicable regulations.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

This patent discloses clinical signage systems with reusable, reversible information cards that advise hospital staff and visitors on status, potential hazards and/or precautions that must be taken upon entering a patient room. In some embodiments, the clinical signage system has hold in place slots where the information cards may be stored with front or back sides facing out to customize the warning information to the particular patient in the hospital room. In some embodiments, the card holder may have additional supplemental card slots for specialized patient information. For example, the card holder may have extra card slots for supplemental cards that are tailored to geriatric or elderly patients, cancer patients, pediatrics, or the like. In certain embodiments, the card holder will be part of a larger wall sign with aesthetic design and additional information such as patient name, patient room number, or hospital direction information.

In certain embodiments, the clinical signage system may include general information signs posted throughout the healthcare facility. These general information signs may include educational and directory information. For example, the general information card may have information directing visitors to nursing or staff stations when they arrive at the facility, or it may contain educational information explaining and describing the warning and other information on the reversible cards of the clinical signage system.

In some embodiments, the clinical signage system has information cards and supplemental information cards made of acrylic glass to allow for cleaning and reduced transmission of bacteria, viruses, or infectious diseases.

In some embodiments, the clinical signage system includes provisions for foam or other friction enhancing material in the information card apertures to prevent them from accidentally moving or being displaced. In other embodiments, the clinical signage system and information cards may be made of or coated with materials, like copper, that are antimicrobial to prevent transmission of disease and simplify cleaning and maintenance requirements.

### BRIEF DESCRIPTION OF THE DRAWINGS

Illustrative embodiments of the present invention are described in detail below with reference to the following drawing figures:

FIG. 1 is a front view of a clinical signage system mounted near a patient room door.

FIG. 2 is a close-up front view of the clinical signage system of FIG. 1.

FIG. 3 is a front view of a general information sign.

FIG. 4A is a front view of a front framing member, shown in isolation, of the clinical signage system of FIG. 1.

FIG. 4B is a front view of a rear framing member, shown in isolation, of the clinical signage system of FIG. 1.

FIG. 4C is a front view of a back plate, shown in isolation, of the clinical signage system of FIG. 1.

FIG. 4D is a front view of an assembled card holder according to one embodiment of the clinical signage system.

FIG. 5A is a front view of a clinical signage system with information cards facing out.

FIG. 5B is a side view of the clinical signage system of FIG. 5A.

FIG. 6A is a front view of four exemplary information cards according to an embodiment of the clinical signage system.

FIG. 6B is a rear view of the four information cards of FIG. 6A.

FIG. 7 shows front and rear views of three supplemental information cards of another embodiment of the clinical signage system.

FIG. 8 is a front view of another embodiment of the clinical signage system in usage with information cards facing both out and in.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

This patent discloses various clinical signage systems to inform visitors, healthcare facility staff, healthcare professionals, and others about risks, precautions, and protocols that must be observed inside a patient room or other area of a medical facility. The clinical signage system is designed to provide clear, concise, and easy to follow information to help ensure that all proper procedures are followed. The system uses a card holder and reusable, reversible information cards to customize and vary the information based on the particular patient and set of circumstances. Reversible cards provide simplicity and ease of use because all necessary information cards are located within the clinical signage system at all times. Thus, there is no need for staff or workers to locate the proper cards as they are always in the clinical signage system. A user may simply reverse the information cards to reveal the proper status, warnings, precautionary, protocol, procedure and/or other information. Furthermore, the particular design of the clinical signage system and material usage makes cleaning easier and helps prevent the spread of bacterial infections, viruses, or other contagions. The signage system herein disclosed is described for use in medical facilities but is not so limited. The signage system and associated method may be applicable in any number of settings, including, but not limited to, industrial, commercial, business, residential, or educational settings.

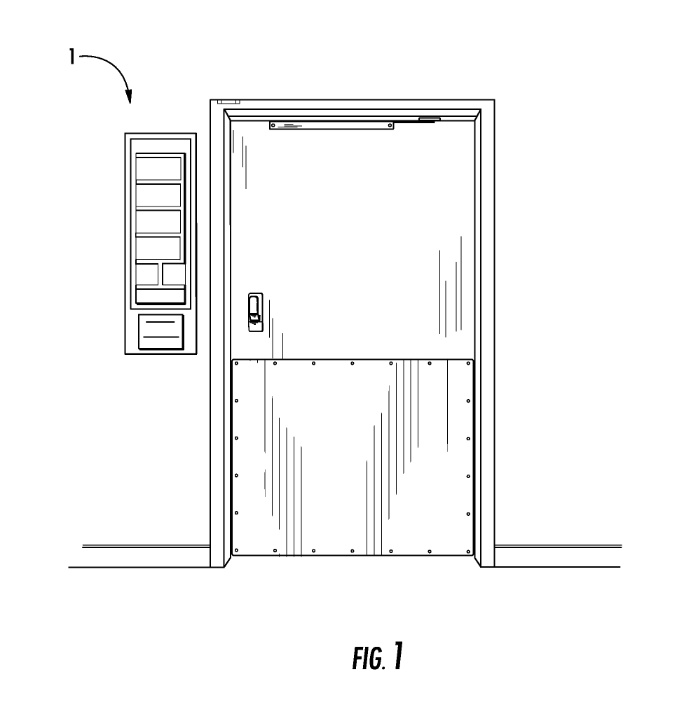

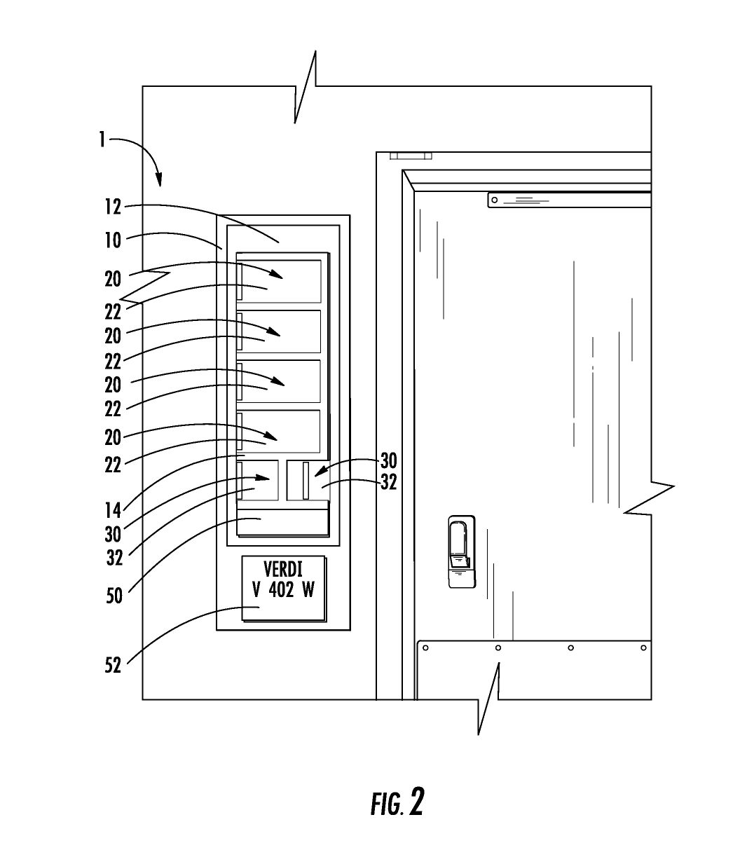

FIGS. 1 and 2 illustrate a non-limiting embodiment of a clinical signage system 1 to help inform visitors, healthcare facility staff and others of precautions and protocols that should be observed while inside the patient room or within a particular area of a medical facility. The clinical signage system 1 is mounted next to the patient door in a position that is easily viewed by persons entering the patient room, and at a height suitable for reaching the sign by healthcare facility staff. As shown, the clinical signage system 1 is shown mounted on the left side of the patient door. However, the clinical signage system 1 may be mounted on either side of the door, or two clinical signage systems 1 may be mounted with one on either side of the patient room door.

The clinical signage system 1 is shown with a plurality of reversible information cards 20. As shown in FIG. 2, the reversible information cards 20 are positioned in the clinical signage system 1 with their back faces 22 facing out. The clinical signage system 1 may optionally include one or more apertures containing supplemental information cards 30 that may be used to convey particularized protocol or warning information. For example, in an elder care or geriatric medicine unit, the supplemental information cards 30 may be used to convey information particular to elder care or geriatric medicine beyond the general information shown on the information cards 20. As with the information cards 20, the supplemental information cards 30 are shown with their back faces 32 facing outwards. The clinical signage system 1 may also include areas or provisions for additional information. For example, a patient name area 50, which may be a small chalk board, marker board, an additional area for inserting a name tag or card, or any other type of method or device for displaying a patient name, is included in the clinical signage system 1. A room placard 52 may be incorporated into the clinical signage system 1 to provide information such as the room name, room number, medical facility wing or department name, other location information, or other information.

Still referring to FIGS. 1 and 2, the clinical signage system 1 includes an outer framing member 14 which frames and may help to guide and hold information cards 20 and supplemental information cards 30 in place. The clinical signage system 1 may also optionally include a sign plate 12 and a decorative plate 10. In some embodiments, the sign plate 12 may be concealed by the outer framing member 14, information cards 20, and/or any optional supplemental cards 30. However, in other embodiments, the sign plate 12 may be larger than the outer framing member 14 and extend into view as a part of the aesthetic design of the clinical signage system 1. Similarly, the decorative plate 10 may be included or omitted depending on the desired design of the clinical signage system 1. As such, the decorative plate 10 and sign plate 12 may be made of any material that fits with the overall design of the medical facility, and may be painted, coated, or otherwise colored to match the interior design of the facility with which the clinical signage system will be used.

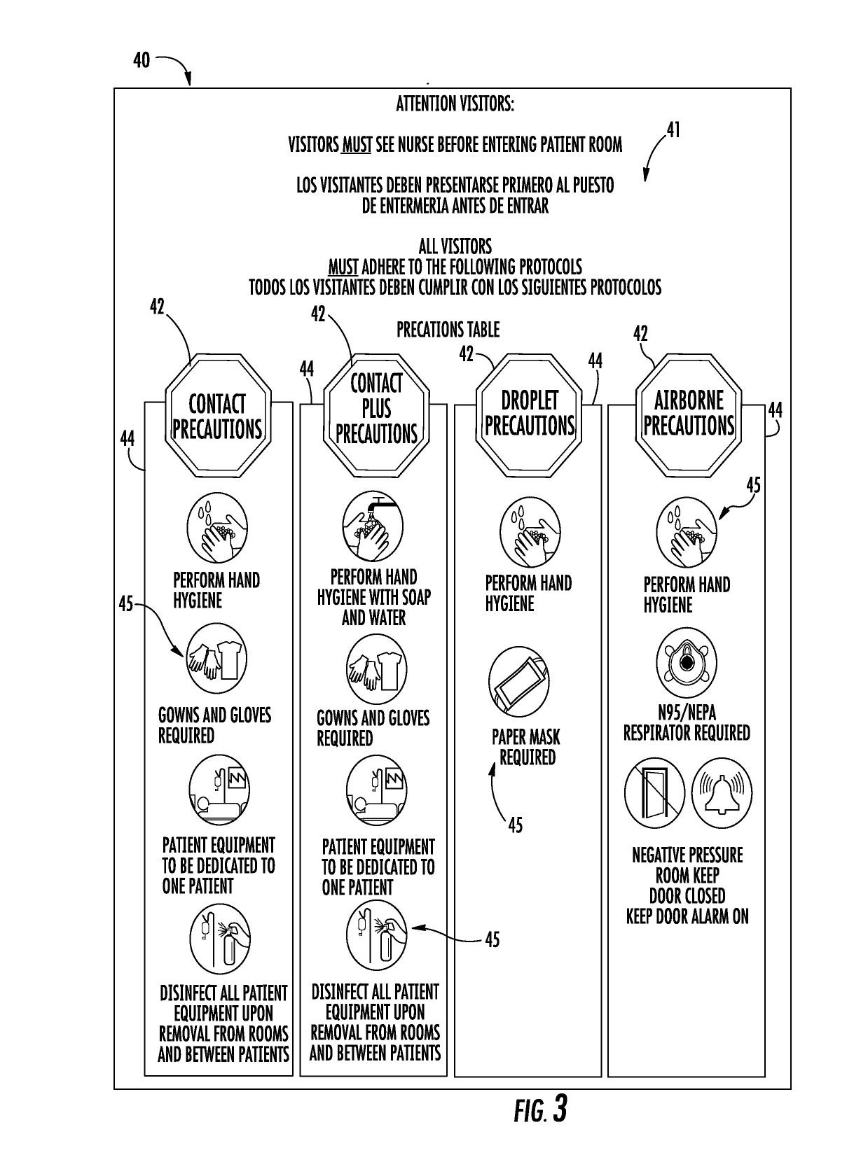

FIG. 3 illustrates a general information card 40. The general information card 40 may be used in conjunction with the signage system 1 to educate visitors, healthcare professionals and others on the meaning of the precautions or other information that are printed on the information cards 20 and supplemental information cards 30 of the clinical signage system 1 (FIG. 2). The general information card 40 may include location information, instructions to visitors for signing in, or any other pertinent information that the medical facility would want to convey to visitors. For example, as shown in FIG. 3, the general information card 40 may optionally include visitor information 41 and a plurality of category symbols 42. Each category symbol 42 is associated with an information box 44 that contains specific protocol or warning information 45 related to that category symbol 42. The arrangement of specific protocol or warning information 45 within the information boxes 44 gives a clear, concise, and easy to understand explanation of the meaning of the information cards 20 (FIG. 2) that will be posted near patient rooms.

The general information card 40 may be made of any suitable material, but preferably is made of materials which are easy to clean or resistant to bacteria, viruses, or other potential contagions. For instance, the general information card 40 may be made of a material that is easy to clean such as, but not limited to, acrylic glass. The general information card 40 may also be made of or coated with a material that has antimicrobial properties such as copper or silver nanoparticles. Incorporation of materials with antimicrobial properties can reduce or eliminate the need for cleaning and maintenance of the general information card 40.

Still referring to FIG. 3, the general information card 40 may take on any number of shapes, sizes, or designs. For example, the general information card 40 may be round, square, oval, or any other shape as desired or required. The general information card 40 may also take on any color, pattern, or material to achieve a specific aesthetic or functional purpose. For example, the general information card 40 may be made of metal, such as stainless steel, aluminum, or copper, acrylic glass, glass, plastic, a composite, polymer, or wood. The general information card 40 may be dyed, colored, or painted to match the design of the medical facility or to enhance visibility. Furthermore, the designs of the category symbols 42 and specific protocol or warning information 45 may be customized to particular applications, such as a geriatric or pediatric department, or for a particular hospital system or healthcare provider. Font type and sizes for the visitor information 41 or specific protocol or warning information 45 may be chosen to aid in clarity and readability, and sized so that a reader can quickly and easily understand the information. The general information card 40 may also take on three dimensional characteristics with symbols or warnings or other text in relief or the use of braille text for the visually impaired. The general information card 40 may be positioned in any suitable location within a medical facility, such as near an elevator bank or the nurses' station.

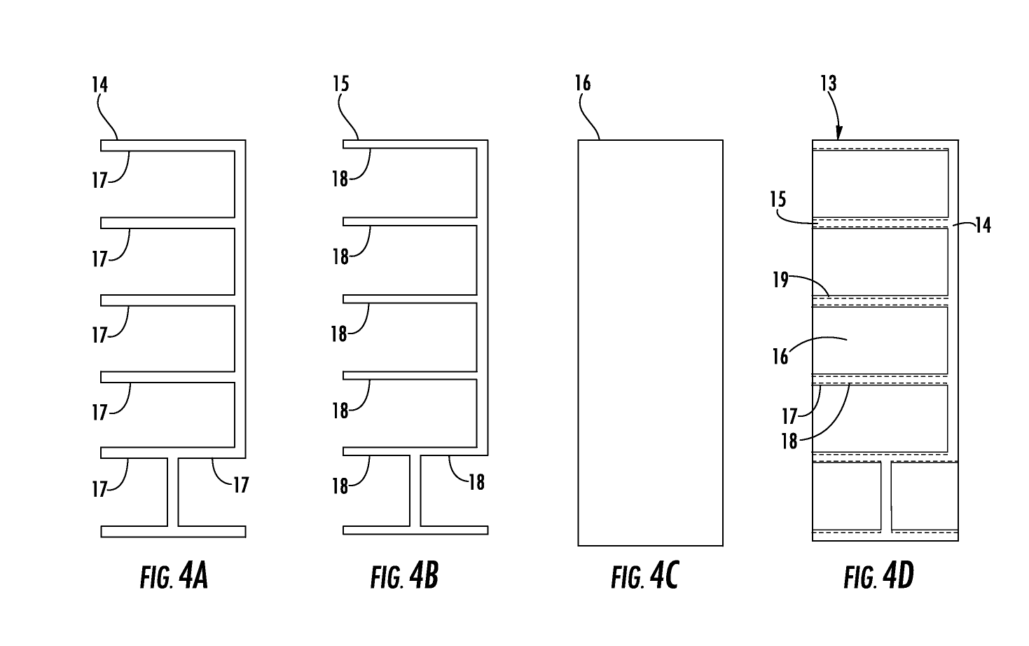

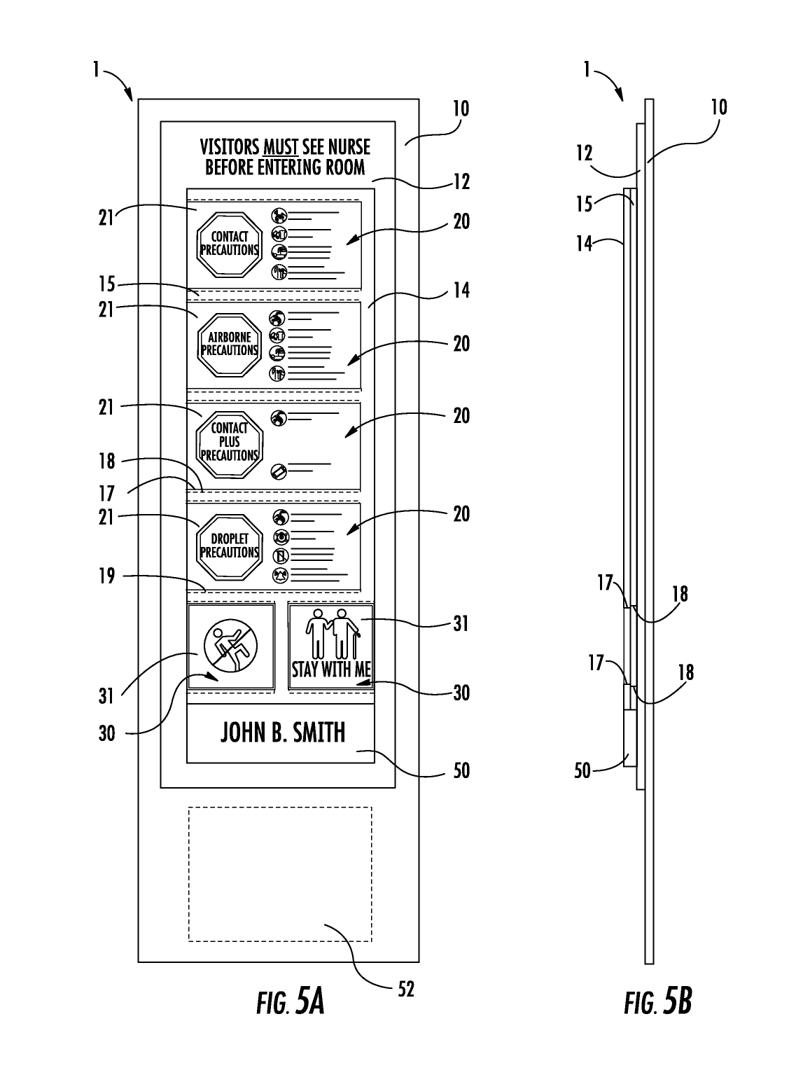

FIGS. 4A-4D illustrate an assembled card holder 13 and its constituent parts. FIG. 4A illustrates a outer framing member 14 which is incorporated into the card holder 13. The outer framing member 14 has a number of outer card apertures 17 which are sized slightly smaller than the information cards 20 or supplemental information cards 30 (FIG. 2) that will be placed within them. This will cause an overlap between the outer card apertures 17 and the information cards 20 or supplemental information cards 30 so that the information cards 20 or supplement information cards 30 may not pass through the outer card apertures 17.

FIG. 4B illustrates an inner framing member 15. Similar to the outer framing member 14, the inner framing member 15 has a plurality of inner card apertures 18. In contrast to the outer card apertures 17, the inner card apertures 18 are sized to be slightly larger than the information cards 20 or supplemental information cards 30 (FIG. 2). The larger size of the inner card apertures 18 allows an information card 20 or supplemental information card 30 to pass through the inner card aperture 18.

In some embodiments, the outer framing member 14 and inner framing member 15 have similar or identical outer perimeter sizes. However, the cross section of the individual arms of the inner framing member 15 is narrower than the cross section of the individual arms of the outer framing member 14. The resulting difference in cross section accounts for the slightly larger size of the inner card apertures 18 compared to the outer card apertures 17.

FIG. 4C illustrates a backing plate 16. The backing plate 16 is incorporated into the assembled card holder 13 to close off the rear portion of the inner card apertures 18. As shown in FIG. 4C, the backing plate 16 has the same or similar outer dimensions as the outer framing member 14 and inner framing member 15 so that it will be partially or completely hidden from view when in use with information cards 20 and/or supplemental information cards 30. However, the backing plate 16 may be configured so it is larger than the outer framing member 14 and therefore visible. In this way, the backing plate 16 may be used as an aesthetic design feature if desired.

FIG. 4D illustrates the assembled card holder 13. The card holder 13 is formed by stacking the inner framing member 15 on top of the backing plate 16, and the outer framing member 14 on top of the inner framing member 15. The difference in size between the outer card aperture 17 and the inner card aperture 18 creates a channel recess 19. The channel recess 19 is disposed between the backing plate 16 and the overhanging lip of the outer card aperture 17 over the inner card aperture 18. The difference in size between the outer card aperture 17 and the inner card aperture 18 may be selected based on a number of factors. The size of the information cards 20 and/or supplemental information cards 30 will be a large factor in the determination of the outer card aperture 17 and inner card aperture 18 sizes. The sizing of the inner card aperture 18, in particular, should account for enough space so that the information cards 20 and/or supplemental information cards 30 may slide in and out of the card holder 13 easily, yet also be tight enough that the information cards 20 and/or supplemental information cards 30 do not inadvertently fall out of the card holder 13. Also, the sizing of the outer card apertures 17 and inner card apertures 18 may take into account a desired size for the channel recess 19 to allow for regular cleaning. In some embodiments, the channel recess 19 should be sized large enough that a finger or cleaning tool may clean out the channel recess 19 and prevent the buildup of dirt, bacteria, or other contagions.

The card holder 13 may be made or assembled through other methods in addition to the stacking configuration described above. Depending on material, cost considerations, or the number of units to be produced, the card holder 13 may be cast, injection molded, stamped, machined, or otherwise fabricated.

The card holder 13 make take on any number of variations or characteristics as necessary for a particular application. For example, the card holder 13 or any of its components may take on any shape or size to match that of the information cards 20 and/or supplemental information cards 30 (FIG. 2). The card holder 13 may be made of any suitable material that may be selected based on factors such as cost, microbial resistance, ease of manufacture, or appearance. Exemplary materials for the card holder 13 or any of its components may include stainless steel, aluminum, or copper, acrylic glass, glass, plastic, a composite, polymer, or wood. Any particular material may be colored, painted, or dyed. Surface treatments for appearance or antimicrobial properties, such as the application of silver nanoparticles, may be incorporated into the card holder 13.

The card holder 13 may take on a wide variety of configurations for any particular applications. As shown in FIG. 4D, the card holder 13 has a generally vertical arrangement for the information cards 20 and a side-by-side arrangement for the supplemental information cards 30. The card holder 13 may, for example, be configured with only the four (or other suitable number) vertically oriented card apertures and omit the apertures for the supplemental information cards 30. Alternatively, the card holder 13 may be configured in a horizontal orientation or as a two dimensional array of card apertures. The orientations of the outer framing member 14 and inner framing member 15 may be reversed so that the outer card aperture 17 and inner card aperture 18 open to the left side. The ability to reverse the orientation of the card apertures provides flexibility in mounting locations for the card holder 13 to account for corners or other obstructions that may be present in the mounting area. The card holder 13 may also be designed so that information cards 20 can be inserted from both directions, or to have a vertical insertion orientation. The card holder 13 may also be configured to hold any suitable number of cards and is not limited to the number shown in the Figures.

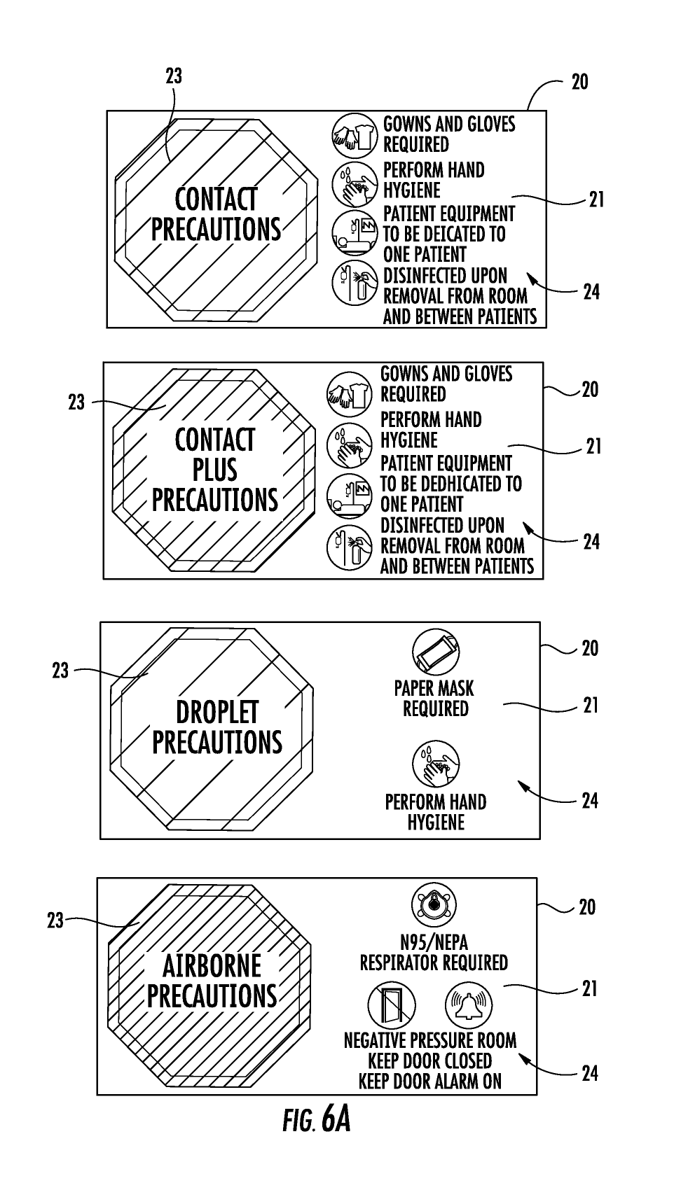

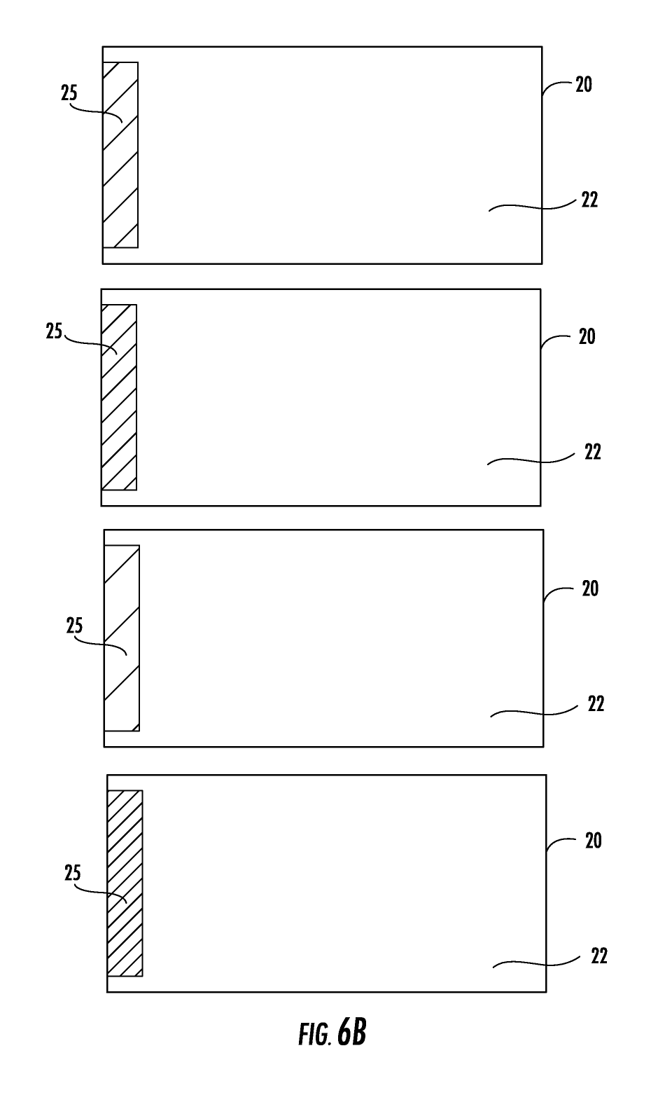

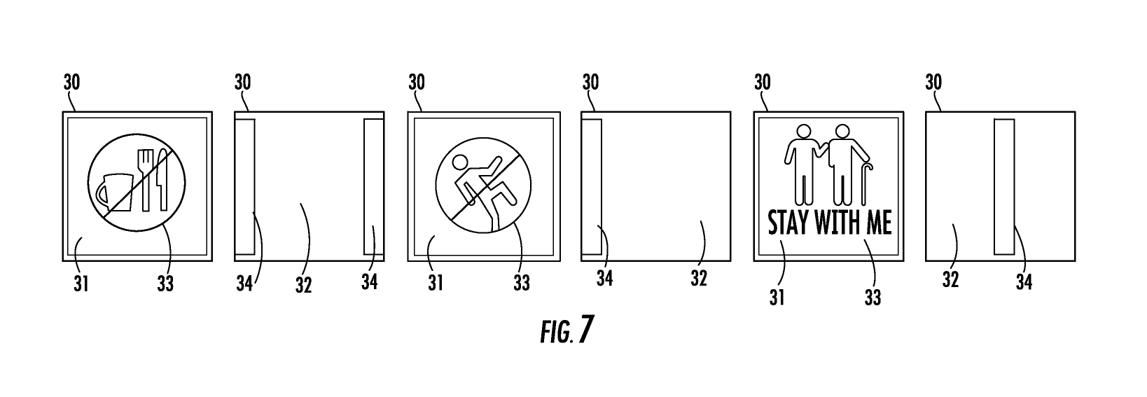

As shown, the outer card aperture 17 and inner card aperture 18 are sized to complement the information card 20 (see e.g., FIGS. 6A-6B) to allow the card to slide in and out of the card aperture but not pass through the outer card aperture 17 in a direction perpendicular to the backing plate 16. Additional methods for securing the information cards 20 and/or supplemental information cards 30 may be used in combination with, or in place of, properly sized outer card apertures 17 and inner card apertures 18. As one non-limiting example, foam or rubber may be inserted into the channel recess to provide friction or interference and prevent accidental movement of the information cards 20 or supplemental information cards 30. Information cards 20 and/or supplemental information cards 30 may be held in the card holder 13 by way of clips, reusable adhesive, hook and loop fasteners, or other attachment means, as well.

FIGS. 5A and 5B illustrate front and side views of an embodiment of the clinical signage system 1 to convey protocol, cautionary, and other information to visitors and healthcare facility staff. The clinical signage system 1 is shown with a plurality of reversible information cards 20 (discussed in more detail below) positioned with their front faces 21 facing out. Specifically, the information cards 20 are disposed within the inner card apertures 18 of the inner framing member 15 and behind the outer card apertures 17 of the outer framing member 14. As discussed above, the information cards 20 are sized to be slightly larger than the outer card apertures 17 and slightly smaller than the inner card apertures 18 so that the information cards 20 will be retained within the clinical signage system 1 by the channel recesses 19. A sign plate 12 (equivalent to the backing plate 16 of FIG. 4) closes off the rear of the inner card aperture 18 and, in some embodiments, extends beyond the boundaries of the inner framing member 15 and outer framing member 14 as a design element. In the illustrated embodiment, a decorative plate 10 is included in the clinical signage system 1 for aesthetic and mounting purposes.

In some embodiments, the clinical signage system 1 may include optional reversible supplemental information cards 30, shown in FIG. 5A with their front faces 31 facing out. As set forth above, a patient name area 50, which may be a small chalk board, marker board, an additional area for inserting a name tag or card, or any other type of method or device for putting a patient name, is included in the clinical signage system 1. A room placard 52 may be incorporated into the clinical signage system 1 to provide information such as the room name, room number, medical facility wing or department name, or other location or desired information.

FIG. 5B is a side view of the clinical signage system 1. In some embodiments, as described above, the clinical signage system 1 may be assembled as a stacked system of layers. The clinical signage system 1 is assembled with a decorative plate 10 closest to the wall or other surface on which the clinical signage system 1 will be used. A sign plate 12 is placed on top of the decorative plate 10. The inner framing member 15 and outer framing member 14 are then stacked on the sign plate 12, respectively. The patient name area 50 may be layered on top of the sign plate 12 as shown, or may be integrated with one of the other layers. The outer card aperture 17 and inner card aperture 18, along with their relative proportions, provide a space for a supplemental information card 30 (not shown) to be placed into the clinical signage system 1 if desired.

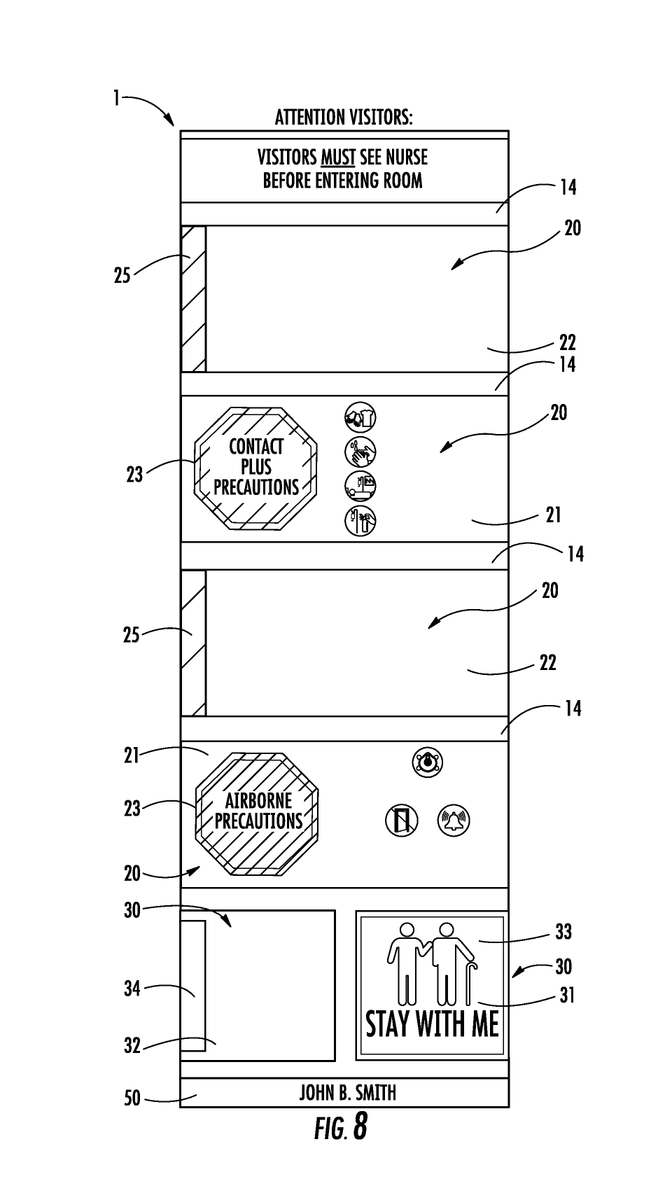

FIGS. 6A, 6B, and 7 illustrate exemplary embodiments of information cards 20 and supplemental information cards 30. Referring to FIG. 6A, each reversible information card 20 has a front face 21. The front face 21 of the information card 20 may be printed with a category symbol 23 and specific protocol, warning, or other information 24. The category symbol 23 may consist of a colored or patterned image incorporating a design and optionally words or descriptive symbols. The particular design or color scheme of the various category symbols 23 may be chosen to indicate relative severity, risk, or simple differentiation between categories. The specific protocol or warning information 24 may consist of colored or black- and -white pictograms and/or text indicating specific practices or cautionary or other information.

Referring to FIG. 6B, each information card 20 has a back face 22. The back face 22 of each information card 20 has a card stripe 25. The card stripe 25 is colored or patterned to match a category symbol 23 on the front face 21 of the information card 20. The card stripe 25 provides a point of reference for a user to quickly and easily identify the appropriate information card 20 when reversing the information card 20 to show the front face 21.

Referring to FIG. 7, each of reversible supplemental information cards 30 has a front face 31 and a back face 32. The front face 31 of each supplemental information card 30 features a symbol or other graphic or text 33 to indicate a particular precaution or risk that may be associated with a patient in the room. The supplemental information cards 30 are typically cards directed towards specific concerns or protocols that may not be generally applicable to all types of patients. For example, supplemental information cards 30 may be used to give notice of particular practices for elderly patients while information cards 20 relay more generally applicable information. Similar to information cards 20, the supplemental information cards 30 each have a back face 32 with card stripes 34. The card stripes 34 provide an indication to a user of what category or precaution a particular supplemental information card 30 corresponds to when the supplemental information card is placed in the clinical signage system 1 (FIG. 2). When the user requires a particular supplemental information card 30 to be positioned with its front face 31 in view, the card stripes 34 on the back face 32 indicate which is the correct supplemental information card 30 to reverse.

The information cards 20 and/or supplemental information cards 30 may be made of any suitable material and in some cases are made of materials which are easy to clean or resistant to bacteria, viruses, or other potential contagions. For instance, the information cards 20 and/or supplemental information cards 30 may be made of a material that is easy to clean such as, but not limited to, acrylic glass. The information cards 20 and/or supplemental information cards 30 may also be made of or coated with a material that has antimicrobial properties such as copper or silver nanoparticles. Incorporation of materials with antimicrobial properties can reduce or eliminate the need for cleaning and maintenance of the information cards 20 and/or supplemental information cards 30.

Still referring to FIGS. 6A, 6B, and 7, the information cards 20 and/or supplemental information cards 30 may take on any number of shapes, sizes, or designs. For example, the information cards 20 and/or supplemental information cards 30 may be round, square, oval, or any other shape as desired or required. In certain embodiments, the information cards 20 and/or supplemental information cards 30 may also take on any color, pattern, or material to achieve a specific aesthetic or functional purpose. For example, the information cards 20 and/or supplemental information cards 30 may be made of metal, such as stainless steel, aluminum, or copper, acrylic glass, glass, plastic, a composite, polymer, or wood. The information cards 20 and/or supplemental information cards 30 may be dyed, colored, or painted to match the design of the medical facility or to enhance visibility. Furthermore, the designs of the category symbols 23, specific protocol or warning or other information 24, and/or symbol or text 33 may be customized to particular applications, such as a geriatric or pediatric department, or for a particular hospital system or healthcare provider. Font sizes for the category symbol 23 or specific protocol or warning or other information 24 may be chosen for its clarity and readability, and sized so that a reader can quickly and easily understand the information. The information cards 20 and/or supplemental information cards 30 may also take on three dimensional characteristics with symbols or warnings or other text in relief or the use of braille text for the visually impaired.

FIG. 8 illustrates a clinical signage system 1 during usage with a plurality of information cards 20 and optional supplemental information cards 30 to convey information about a particular patient room or area of a medical facility. A subset of the information cards 20 are positioned with their back faces 22 visible, while the balance of the information cards 20 are positioned with their front faces 21 visible to convey information specific to the patient room or area of a medical facility. Similarly, a subset of the supplemental information cards 30 are positioned with their back faces 32 visible, while the balance of the supplemental information cards 30 are positioned with their front faces 31 visible. When the front face 21 of the information card 20 is visible, the category symbol 23 and specific protocol or warning or other information 24 are visible. When the back face 22 of the information card 20 is visible, the card stripe 25 can be seen. Similarly, the symbol 33 and card stripe 34 of the supplemental information cards 30 are visible when the front face 31 and back face 32 of the supplemental information card 30 is visible, respectively. Because of the nature of the specific protocol or warning or other information 24 and symbols 33, they may often be mutually exclusive in use and not all information cards 20 or supplemental information cards 30 will be positioned with their front faces 21, 31 visible during use. As discussed, in some embodiments, a patient name area 50 is included in the clinical signage system 1.

The clinical signage system 1 includes a number of outer framing members 14 which hold the information cards 20 and supplemental information cards 30 in place. As shown in FIG. 8, certain embodiments of the clinical signage system 1 may allow for the information cards 20 to slide left or right into and out of the clinical signage system 1. The clinical signage system 1 can be configured to accommodate any suitable number of information cards 20 and/or supplemental information cards 30 and is not limited to the particular arrangement illustrated.

The foregoing description of aspects and features of the disclosure, including illustrated examples, has been presented only for the purpose of illustration and description and is not intended to be exhaustive or to limit the disclosure to the precise forms disclosed. For example, the signage system and associated method may be modified for use in any applicable setting including, but not limited to, industrial, commercial, business, residential, or educational settings. Numerous modifications, adaptations, and uses thereof will be apparent to those skilled in the art without departing from the scope of this disclosure. Aspects and features from each example disclosed can be combined with any other example. The illustrative examples described above are given to introduce the reader to the general subject matter discussed here and are not intended to limit the scope of the disclosed concepts.

That which is claimed is:

1. A signage system for communicating room or area status, warnings or precautionary information comprising:
a card holder comprising a plurality of card apertures;
a plurality of reversible information cards each having a front face and a back face;
at least one warning or precaution symbol on each of the front faces of the plurality of reversible information cards; and
wherein each of the plurality of reversible information cards is removably disposed within one of the plurality of card apertures.

2. The signage system of claim 1, wherein the card holder further comprises:
at least one supplemental card aperture; and
at least one supplemental information card.

3. The signage system of claim 1, wherein the plurality of reversible information cards comprise acrylic glass.

4. The signage system of claim 1, wherein the plurality of reversible information cards comprise copper.

5. The signage system of claim 1, wherein the plurality of reversible information cards comprise an antimicrobial coating.

6. The signage system of claim 5, wherein the antimicrobial coating comprises silver nanoparticles.

7. The signage system of claim 1, further comprising a card stripe on each of the back faces of the plurality of reversible information cards, wherein the card stripe is designed to convey information regarding the at least one warning or precaution symbol on the front face of the reversible information card.

8. The signage system of claim 1, further comprising a general information card.

9. The signage system of claim 8, wherein the general information card further comprises:
a plurality of warning or precaution symbols; and
wherein the plurality of warning or precautions symbols matches the warning or precaution symbols on the front faces of the plurality of reversible information cards.

10. The signage system of claim 1, wherein the card holder comprises acrylic glass.

11. The signage system of claim 1, wherein the card holder comprises copper.

12. The signage system of claim 1, wherein the card holder comprises an antimicrobial coating.

13. The signage system of claim 12, wherein the antimicrobial coating comprises silver nanoparticles.

14. The signage system of claim 1, wherein the card holder further comprises:
an inner framing member comprising a plurality of inner card apertures; and
an outer framing member comprising a plurality of outer card apertures;
wherein each of the inner card apertures is larger than each of the outer card apertures and together form the plurality of card apertures; and
wherein each of the plurality of inner card apertures is larger than each of the plurality of reversible information cards and each of the plurality of outer card apertures is smaller than each of the plurality of reversible information cards.

15. The signage system of claim 14, wherein each of the plurality of aperture overlaps comprise a channel recess.

16. The signage system of claim 15, wherein at least one of the plurality of channel recesses contains a material comprising foam or rubber.

17. The signage system of claim 1, further comprising a patient name area.

18. The signage system of claim 1, further comprising a room information placard.

19. A method for communicating at least one of patient room or facility area status, warnings, or precautionary information, the method comprising:
providing a plurality of reversible information cards each having a front face and a back face;
wherein the front face of each of the plurality of reversible information cards provides at least one warning or precaution symbol; and
wherein the back face of each of the plurality of reversible information cards provides a card strip correlated to the at least one warning or precaution symbol on the front face of one of the plurality of reversible information cards;
providing a card holder comprising a plurality of card apertures each configured to removably house at least one of the plurality of reversible information cards;
selecting a subset of the plurality of reversible information cards for displaying the at least one warning or precaution symbols on the front faces of the selected subset of the plurality of reversible information cards based on patient or patient room or facility area status or conditions and based on the card strip on the back face of each of the subset of the plurality of reversible information cards, the card strip correlating to the at least one warning or precaution symbol; and
reversing the subset of the plurality of reversible information cards in the card apertures of the card holder to display the at least one warning or precaution symbols on the front faces of the subset of the plurality of reversible information cards.

20. A signage system for communicating at least one of patient room or facility area status, warnings, or precautions, the signage system comprising:
a card holder comprising a plurality of card apertures;
a plurality of reversible information cards;
an inner framing member comprising a plurality of inner card apertures; and
an outer framing member comprising a plurality of outer card apertures;
wherein each of the inner card apertures is larger than each of the outer card apertures and together form the plurality of card apertures;
wherein each of the plurality of inner card apertures is larger than each of the plurality of reversible information cards and each of the plurality of outer card apertures is smaller than each of the plurality of reversible information cards; and
wherein each of the plurality of reversible information cards is removably disposed within of the plurality of card apertures.
